(19) United States
(12) Patent Application Publication
(10) Pub. No.: US 2014/0079138 A1
(43) Pub. Date: Mar. 20, 2014

(54) SIMPLIFIICATION OF PIC_ORDER_CNT_LSB CALCULATION IN HM8

(71) Applicant: SONY CORPORATION, Tokyo (JP)

(72) Inventors: Cheung Auyeung, Sunnyvale, CA (US); Ali Tabatabai, Cupertino, CA (US); Jun Xu, Sunnyvale, CA (US)

(73) Assignee: SONY CORPORATION, Tokyo (JP)

(21) Appl. No.: 13/793,987

(22) Filed: Mar. 11, 2013

Related U.S. Application Data
(60) Provisional application No. 61/701,078, filed on Sep. 14, 2012.
(60) Provisional application No. 61/708,294, filed on Oct. 1, 2012.

(51) Int. Cl. H04N 7/26

(52) U.S. Cl. CPC H04N 19/00; H04N 19/00533
USPC 375/240.25; 375/240.01

(57) ABSTRACT

The specification and calculation of PicOrderCntMsb in WD8 is simplified without changing the semantics in WD8. Four arithmetic-logic operations are removed, and the implicit assumption that the subtraction in the calculation is based on unsigned integer arithmetic in HM8 is removed. The implementation is correct for both signed and unsigned integer arithmetic without using “and” operations.

### CROSS-REFERENCE TO RELATED APPLICATION(S)

This application claims priority under 35 U.S.C. §119(e) of the U.S. Provisional Patent Application Ser. No. 61/701,078, filed Sep. 14, 2012 and titled, “SIMPLIFICATION OF PIC_ORDER_CNT_LSB CALCULATION IN HM8,” and U.S. Provisional Patent Application Ser. No. 61/708,294, filed Oct. 1, 2012 and titled, “SIMPLIFICATION OF PIC_ORDER_CNT_LSB CALCULATION IN HM8,” both of which are hereby incorporated by reference in their entireties for all purposes.

### FIELD OF THE INVENTION

The present invention relates to the field of video encoding. More specifically, the present invention relates to high efficiency video coding.

### BACKGROUND OF THE INVENTION

High Efficiency Video Coding (HEVC) is a draft video compression standard, a successor to H.264/MPEG-4 AVC (Advanced Video Coding) under joint development by the ISO/IEC Moving Picture Experts Group (MPEG) and ITU-T Video Coding Experts Group (VCEG) as ISO/IEC 23008-2 MPEG-H Part 2 and ITU-T H.HEVC. MPEG and VCEG have established a Joint Collaborative Team on Video Coding (JCT-VC) to develop the HEVC standard. HEVC improves video quality, doubles the data compression ratio compared to H.264, and can support 8K UHD and resolutions up to 8192×4320.

### SUMMARY OF THE INVENTION

The specification and calculation of PicOrderCntMsb in HEVC working draft 8 (WD8) is simplified without changing the semantics in WD8. Four arithmetic-logic operations are removed, and the implicit assumption that the subtraction in the calculation is based on unsigned integer arithmetic in WD8 is removed. The implementation is correct for both signed and unsigned integer arithmetic.

In one aspect, a method of video encoding programmed in a memory of a device comprises acquiring video data and encoding the video data, including calculating a picture order count in the video data using signed or unsigned computing without using “and” operations. Calculating the picture order count is limited to two “compare” operations. Calculating the picture order count further comprises determining if a previous picture order count least significant bit is greater than or equal to a current picture order count least significant bit plus half of a maximum picture order count least significant bit, if the previous picture order count least significant bit is greater than or equal to the current picture order count least significant bit plus half of the maximum picture order count least significant bit, then a picture order count most significant bit is the previous picture order count most significant bit plus the maximum picture order count least significant bit, otherwise if the picture order count least significant bit is greater than the previous picture order count least significant bit plus half of the maximum picture order count least significant bit, then the picture order count most significant bit is the previous picture order count most significant bit minus the maximum picture order count least significant bit, otherwise the picture order count most significant bit is the previous picture order count most significant bit. The device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

In another aspect, a method of calculating a picture order count programmed in a memory of a device comprises determining if a previous picture order count least significant bit is greater than or equal to a current picture order count least significant bit plus half of a maximum picture order count least significant bit, if the previous picture order count least significant bit is greater than or equal to the current picture order count least significant bit plus half of the maximum picture order count least significant bit, then a picture order count most significant bit is the previous picture order count most significant bit plus the maximum picture order count least significant bit, otherwise if the picture order count least significant bit is greater than the previous picture order count least significant bit plus half of the maximum picture order count least significant bit, then the picture order count most significant bit is the previous picture order count most significant bit minus the maximum picture order count least significant bit and otherwise the picture order count most significant bit is the previous picture order count most significant bit. Calculating the picture order count avoids using “and” operations. Calculating the picture order count is limited to two “compare” operations. The device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

In another aspect, an encoder within a device comprises an acquisition module configured for acquiring video data and an encoding module configured for encoding the video data including calculating a picture order count in the video data using signed or unsigned computing without using “and” operations. Calculating the picture order count is limited to two “compare” operations. Calculating the picture order count further comprises: determining if a previous picture order count least significant bit is greater than or equal to a current picture order count least significant bit plus half of a maximum picture order count least significant bit, if the previous picture order count least significant bit is greater than or equal to the current picture order count least significant bit plus half of the maximum picture order count least significant bit, then a picture order count most significant bit is the previous picture order count most significant bit plus the maximum picture order count least significant bit, otherwise if the picture order count least significant bit is greater than the previous picture order count least significant bit plus half of the maximum picture order count least significant bit, then the picture order count most significant bit is the previous picture order count most significant bit minus the maximum picture order count least significant bit, otherwise the picture order count most significant bit is the previous picture order count most significant bit. The device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

In another aspect, a decoder within a device comprises an receiving module configured for receiving encoded video data and an decoding module configured for decoding the encoded video data, wherein the encoded video data is encoded by calculating a picture order count in the video data using signed or unsigned computing without using “and” operations. Calculating the picture order count is limited to two “compare” operations. Calculating the picture order count further comprises determining if a previous picture order count least significant bit is greater than or equal to a current picture order count least significant bit plus half of a maximum picture order count least significant bit, if the previous picture order count least significant bit is greater than or equal to the current picture order count least significant bit plus half of the maximum picture order count least significant bit, then a picture order count most significant bit is the previous picture order count most significant bit plus the maximum picture order count least significant bit, otherwise if the picture order count least significant bit is greater than the previous picture order count least significant bit plus half of the maximum picture order count least significant bit, then the picture order count most significant bit is the previous picture order count most significant bit minus the maximum picture order count least significant bit, otherwise the picture order count most significant bit is the previous picture order count most significant bit. The device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

In yet another aspect, an apparatus comprises a non-transitory memory for storing an application, the application for: determining if a previous picture order count least significant bit is greater than or equal to a current picture order count least significant bit plus half of a maximum picture order count least significant bit, if the previous picture order count least significant bit is greater than or equal to the current picture order count least significant bit plus half of the maximum picture order count least significant bit, then a picture order count most significant bit is the previous picture order count most significant bit plus the maximum picture order count least significant bit, otherwise if the picture order count least significant bit is greater than the previous picture order count least significant bit plus half of the maximum picture order count least significant bit, then the picture order count most significant bit is the previous picture order count most significant bit minus the maximum picture order count least significant bit and otherwise the picture order count most significant bit is the previous picture order count most significant bit and a processing component coupled to the memory, the processing component configured for processing the application. Calculating the picture order count avoids using “and” operations. Calculating the picture order count is limited to two “compare” operations.

### BRIEF DESCRIPTION OF THE DRAWINGS

FIG. 1 illustrates a flowchart of a method of video coding according to some embodiments.

FIG. 2 illustrates a flowchart of a method of calculating picture order count according to some embodiments.

FIG. 3 illustrates a block diagram of an exemplary computing device configured to implement the video coding method according to some embodiments.

FIG. 4 illustrates a general diagram of an HEVC encoder according to some embodiments.

FIG. 5 illustrates a general diagram of an HEVC decoder according to some embodiments.

### DETAILED DESCRIPTION OF THE PREFERRED EMBODIMENT

In the working draft specification 8 of HEVC (WD8), the derivation of PicOrderCntMsb is specified with the implicit assumption that unsigned integer arithmetic is used. Consequently extra checking is included in the derivation to guarantee that subtraction of two unsigned integers produces meaningful results.

In High Efficiency Video Coding (HEVC) WD8, unsigned arithmetic is implicitly used:

if ((pic_order_cnt_lsb < prevPicOrderCntLsb) &&

((prevPicOrderCntLsb − pic_order_cnt_lsb) >=
(MaxPicOrderCntLsb / 2)))

| PicOrderCntMsb = prevPicOrderCntMsb + | |
|---|---|
| MaxPicOrderCntLsb | (8-1) |

else if (pic_order_cnt_lsb > prevPicOrderCntLsb) &&

((pic_order_cnt_lsb − prevPicOrderCntLsb) >
(MaxPicOrderCntLsb / 2)))

PicOrderCntMsb = prevPicOrderCntMsb − MaxPicOrderCntLsb

else

PicOrderCntMsb = prevPicOrderCntMsb

The (pic_order_cnt_lsb<prevPicOrderCntLsb) in the first “if” statement in 8-1 is there to guarantee that (prevPicOrderCntLsb−pic_order_cnt_lsb) is always non-negative. In fact, if signed arithmetic is used in the subtraction, the condition

(prevPicOrderCntLsb−pic_order_cnt_lsb)>=(MaxPicOrder CntLsb/2)

implies

(pic_order_cnt_lsb<prevPicOrderCntLsb),

and therefore it is redundant for signed arithmetic.

Similarly, the (pic_order_cnt_lsb>prevPicOrderCntLsb) in the second “if” statement in (8-1) is there to guarantee that (pic_order_cnt_lsb−prevPicOrderCntLsb) is always non-negative. In fact, if signed arithmetic is used in the subtraction, the condition

(pic_order_cnt_lsb−prevPicOrderCntLsb)>MaxPicOrderCntLsb/2))

implies

(pic_order_cnt_lsb>prevPicOrderCntLsb),

and therefore it is redundant for signed arithmetic. Therefore, unsigned arithmetic is implicitly used in 8-1.

A modified PicOrderCntMsb derivation is described herein so that the specification and computation are correct for both signed arithmetic and unsigned arithmetic. The modified version also removes two “compare” operations and two “and” operations:

if (prevPicOrderCntLsb >= (pic_order_cnt_lsb + MaxPicOrderCntLsb /
2))

PicOrderCntMsb = prevPicOrderCntMsb + MaxPicOrderCntLsb

else if (pic_order_cnt_lsb > prevPicOrderCntLsb +
MaxPicOrderCntLsb / 2))

PicOrderCntMsb = prevPicOrderCntMsb − MaxPicOrderCntLsb

else

PicOrderCntMsb = prevPicOrderCntMsb

The modified version is shown to be mathematically equivalent to the WD8 specification as below in two steps. In the first step, the WD8 text below:

if( ( pic_order_cnt_lsb < prevPicOrderCntLsb) &&

((prevPicOrderCntLsb − pic_order_cnt_lsb) >=
(MaxPicOrderCntLsb / 2)))

PicOrderCntMsb = prevPicOrderCntMsb + MaxPicOrderCntLsb

else if( (pic_order_cnt_lsb > prevPicOrderCntLsb) &&

((picOrderCntLsb − prevPicOrderCntLsb) >
(MaxPicOrderCntLsb / 2)))

PicOrderCntMsb = prevPicOrderCntMsb − MaxPicOrderCntLsb

else

PicOrderCntMsb = prevPicOrderCntMsb

is shown to be equivalent to the following:

if(

(prevPicOrderCntLsb − pic_order_cnt_lsb) >=
(MaxPicOrderCntLsb / 2))

PicOrderCntMsb = prevPicOrderCntMsb + MaxPicOrderCntLsb

else if(

(picOrderCntLsb − prevPicOrderCntLsb) >
(MaxPicOrderCntLsb / 2))

PicOrderCntMsb = prevPicOrderCntMsb − MaxPicOrderCntLsb

else

PicOrderCntMsb = prevPicOrderCntMsb

In the second step, written as:

if (prevPicOrderCntLsb >= (pic_order_cnt_lsb + MaxPicOrderCntLsb /
2))

PicOrderCntMsb = prevPicOrderCntMsb + MaxPicOrderCntLsb

else if (pic_order_cnt_lsb > prevPicOrderCntLsb +
MaxPicOrderCntLsb / 2))

PicOrderCntMsb = prevPicOrderCntMsb − MaxPicOrderCntLsb

else

PicOrderCntMsb = prevPicOrderCntMsb

To simplify the analysis of the first step, let:

C = pic_order_cnt_lsb
P = prevPicOrderCntLsb
M = MaxPicOrderCntLsb and M > 0

Then (8-1) is able be written as:

If ( (C < P) && ((P − C) >= M/2))

PicOrderCntMsb = prevPicOrderCntMsb + MaxPicOrderCntLsb

else if( (C> P) && ( (C−P)> M/2))

PicOrderCntMsb = prevPicOrderCntMsb − MaxPicOrderCntLsb

else

PicOrderCntMsb = prevPicOrderCntMsb

The (8-1) is able to be rewritten as three separate conditions so that each condition is able to be studied independently. Condition A:

If( (C< P) && ((P − C) >= M/2))

PicOrderCntMsb = prevPicOrderCntMsb + MaxPicOrderCntLsb

### Condition B:

If (((C>=P) [symbol] ((P−C) <M/2)) &&((C>P) && ((C−P)>M/2)))

PicOrderCntMsb = prevPicOrderCntMsb − MaxPicOrderCntLsb

### Condition C:

If (((C>=P) [symbol] ((P−C)<M/2))&&((C<=P) [symbol] ((C−P)<=M/2)))

PicOrderCntMsb = prevPicOrderCntMsb

### The Condition A

If ( (C < P) && ( (P − C) >= M/2))

PicOrderCntMsb = prevPicOrderCntMsb + MaxPicOrderCntLsb

is able to be simplified as the following. Since ((P−C)>0) is a superset of ((P−C)>=M/2)), condition A is equivalent to:

If ((P−C)>=M/2)

PicOrderCntMsb = prevPicOrderCntMsb + MaxPicOrderCntLsb

### The Condition B

If (((C>=p) [symbol] ((P−C)<M/2))&&((C>P)&&((C−P)> M/2)))

PicOrderCntMsb = prevPicOrderCntMsb − MaxPicOrderCntLsb

is able to be simplified as the following:
The Condition B is equivalent to:

If (((C>=P) && (C>P) && ((C−P) > M/2)) [symbol] (((P − C) < M/2) &&
(C> P) && ((C − P) > M/2)))

PicOrderCntMsb = prevPicOrderCntMsb − MaxPicOrderCntLsb

The right hand side of the [symbol] operator becomes:

((C−P)>−M/2)&&((C−P)>0)&&((C−P)>M/2)=((C−P)>M/2)

The left hand side of the [symbol] operator becomes:

((C−P)>=0)&&((C−P)>0)&&((C−P)>M/2)=((C−P)>M/2)

The condition B becomes:

If ((C−P)>M/2))

PicOrderCntMsb = prevPicOrderCntMsb − MaxPicOrderCntLsb

### Condition C

if (((C>=P) [symbol] ((P−C)<M/2))&&((C<P) [symbol] ((C−P) <=M/2)))

PicOrderCntMsb = prevPicOrderCntMsb

is able to be simplified as the following.
The Condition C is equivalent to:

If( ((C>=P)&&(C<=P))

[symbol]

((C>=P)&&((C−P) <= M/2)) [symbol]
(((P−C)< M/2) && (C<=P)) [symbol]
(((P−C)<M/2) && ((C−P)<=M/2)))

PicOrderCntMsb = prevPicOrderCntMsb

This is equivalent to:

if (( ((C−P)>=0)&&((C−P)<=0))

[symbol]

(((C−P)>=0)&&((C−P) <= M/2)) [symbol]
(((C−P)> −M/2) && ((C−P)<=0)) [symbol]
(((C−P)>−M/2) && ((C−P)<=M/2)))

PicOrderCntMsb = prevPicOrderCntMsb

Since the last operand of the OR operators (((C−P)>−M/2)&&((C−P)<=M/2)) is a superset of (((C−P)>−M/2)&&((C−P)<=0)) and a superset of (((C−P)>=0)&&((C−P)<=M/2)) and a superset of (((C−P)>=0)&&((C−P)<=0)), the condition C becomes:

If( ((P−C)<M/2) && ((C−P)<=M/2))

PicOrderCntMsb = prevPicOrderCntMsb

The conclusion from these calculations in Condition A, Condition B and Condition C is: the equation (8-1) is equivalent, in terms of results, to:

if(

(prevPicOrderCntLsb − pic_order_cnt_lsb) >=
(MaxPicOrderCntLsb / 2) )

PicOrderCntMsb = prevPicOrderCntMsb + MaxPicOrderCntLsb
else if(

(pic_order_cnt_lsb − prevPicOrderCntLsb) >

(MaxPicOrderCntLsb / 2) )
PicOrderCntMsb = prevPicOrderCntMsb − MaxPicOrderCntLsb
else

PicOrderCntMsb = prevPicOrderCntMsb

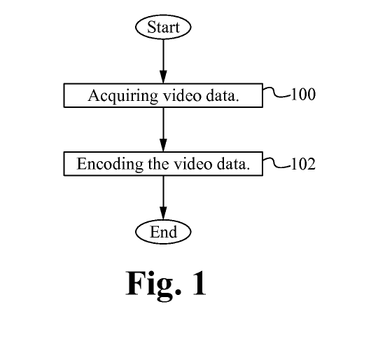

FIG. 1 illustrates a flowchart of a method of video encoding according to some embodiments. In the step 100, video data is acquired. In the step 102, the video data is encoded. Encoding the video includes a modified calculation of a Picture Order Count Msb. The modified calculation of the Picture Order Count Msb is performed without four arithmetic-logic operations. Specifically, two “compare” operations and two “and” operations are removed. Additionally, the implicit assumption that the subtraction in the calculation is based on unsigned integer arithmetic is removed. The modified calculation is correct for both signed and unsigned integer arithmetic. In some embodiments, more or fewer steps are implemented. In some embodiments, the order of the steps is modified.

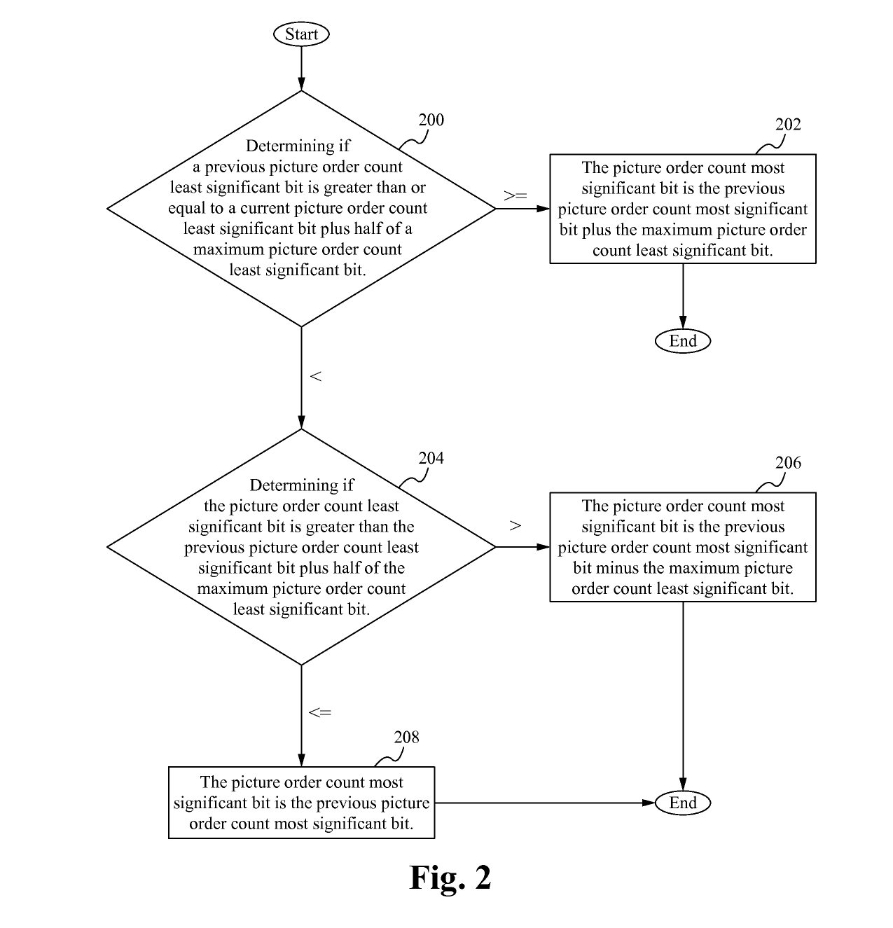

FIG. 2 illustrates a flowchart of a method of calculating picture order count according to some embodiments. In the step 200, it is determined if a previous picture order count least significant bit is greater than or equal to a current picture order count least significant bit plus half of a maximum picture order count least significant bit. In the step 202, if the previous picture order count least significant bit is greater than or equal to the current picture order count least significant bit plus half of the maximum picture order count least significant bit, then a picture order count most significant bit is the previous picture order count most significant bit plus the maximum picture order count least significant bit. In the step 204, otherwise, it is determined if the picture order count least significant bit is greater than the previous picture order count least significant bit plus half of the maximum picture order count least significant bit. In the step 206, if the picture order count least significant bit is greater than the previous picture order count least significant bit plus half of the maximum picture order count least significant bit, then the picture order count most significant bit is the previous picture order count most significant bit minus the maximum picture order count least significant bit. In the step 208, otherwise, the picture order count most significant bit is the previous picture order count most significant bit. In some embodiments, more or fewer steps are implemented. In some embodiments, the order of the steps is modified.

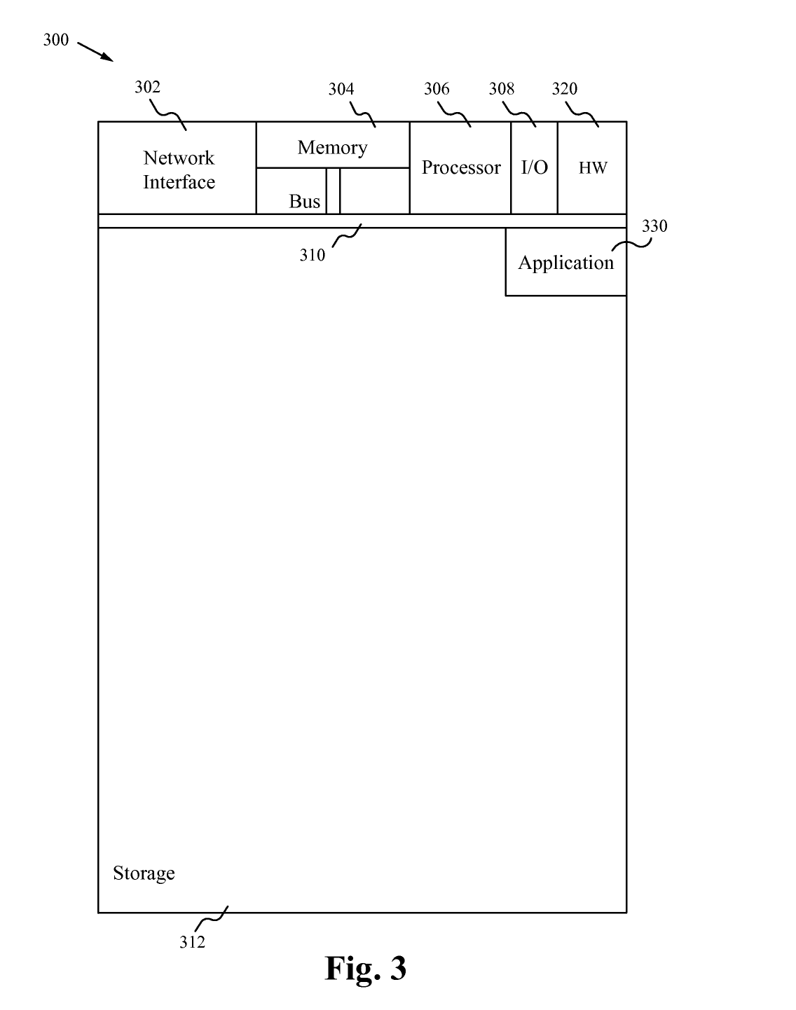

FIG. 3 illustrates a block diagram of an exemplary computing device configured to implement the video encoding method according to some embodiments. The computing device 300 is able to be used to acquire, store, compute, process, communicate and/or display information such as images and videos. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, screen, printer, modem, touchscreen, button interface and other devices. Video coding application(s) 330 used to perform the video coding method are likely to be stored in the storage device 312 and memory 304 and processed as applications are typically processed. More or less components shown in FIG. 3 are able to be included in the computing device 300. In some embodiments, video coding hardware 320 is included. Although the computing device 300 in FIG. 3 includes applications 330 and hardware 320 for the video coding method, the video coding method is able to be implemented on a computing device in hardware, firmware, software or any combination thereof. For example, in some embodiments, the video coding applications 330 are programmed in a memory and executed using a processor. In another example, in some embodiments, the video coding hardware 320 is programmed hardware logic including gates specifically designed to implement the video coding method.

In some embodiments, the video coding application(s) 330 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

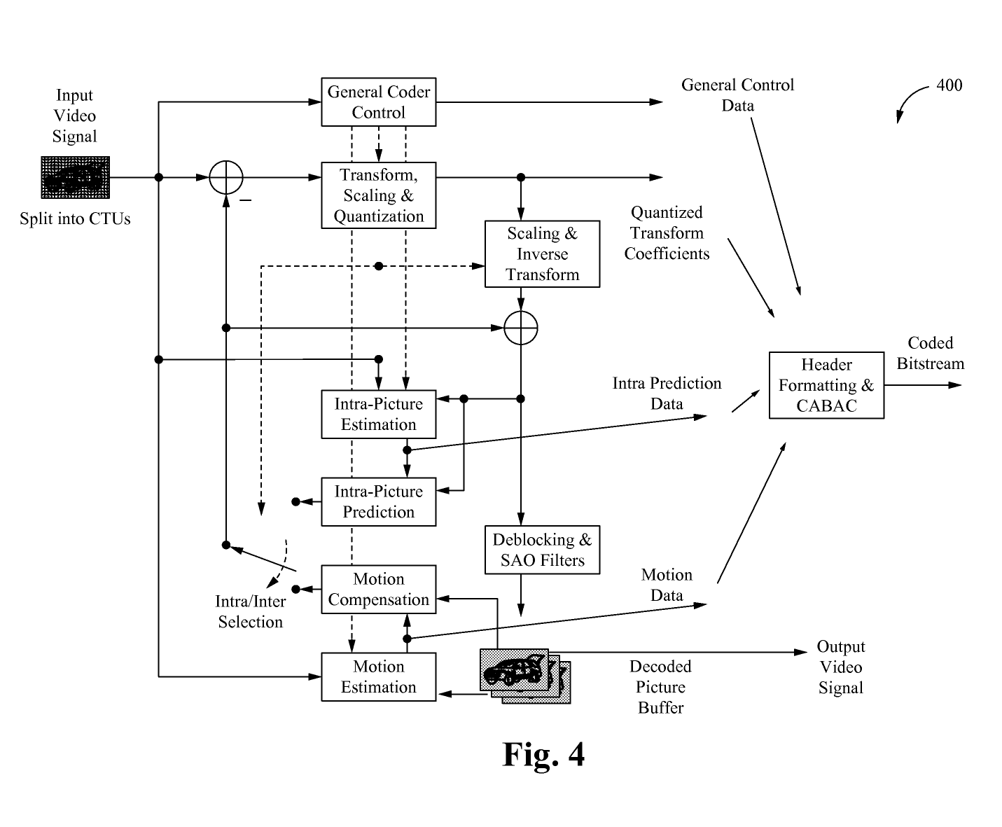

FIG. 4 illustrates a general diagram of an HEVC encoder according to some embodiments. The encoder 400 includes a general coder control component, a transform scaling and quantization component, a scaling and inverse transform component, an intra-picture estimation component, a filter control analysis component, an intra-picture prediction component, a deblocking and SAO filters component, a motion compensation component, a motion estimation component, and a header formatting and CABAC component. An input video signal is received by the encoder 400 and is split into Coding Tree Units (CTUs). The HEVC encoder components process the video data using the modified coding scheme and generate a coded bitstream.

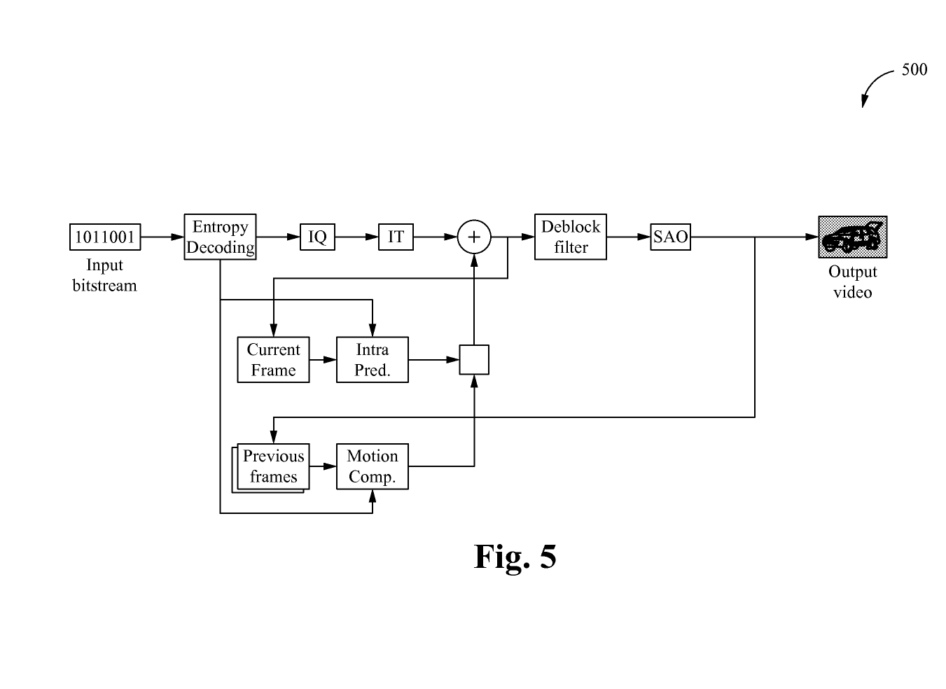

FIG. 5 illustrates a general diagram of an HEVC decoder according to some embodiments. The decoder 500 includes an entropy decoding component, an inverse quantization component, an inverse transform component, a current frame component, an intra prediction component, a previous frames component, a motion compensation component, a deblocking filter, an SAO component and an adaptive loop filter. An input bitstream (e.g., a coded video) is received by the decoder 500, and a decoded bitstream is generated for display.

To utilize the video coding method, a device such as a digital camera is able to be used to acquire a video. The video coding method is automatically used when performing video processing. The video coding method is able to be implemented automatically without user involvement.

In operation, the video coding method enables encoding of the video using a modified calculation of a Picture Order Count Msb. The modified calculation of the Picture Order Count Msb is performed without four arithmetic-logic operations. Specifically, two “compare” operations and two “and” operations are removed. Additionally, the implicit assumption that the subtraction in the calculation is based on unsigned integer arithmetic is removed. The modified calculation is correct for both signed and unsigned integer arithmetic.

### Some Embodiments of Extension of Simplification of Pic_Order_Cnt_Lsb Calculation in HM8

1. A method of video encoding programmed in a memory of a device comprising:
   a. acquiring video data; and
   b. encoding the video data, including calculating a picture order count in the video data using signed or unsigned computing without using “and” operations.
2. The method of clause 1 wherein calculating the picture order count is limited to two “compare” operations.
3. The method of clause 1 wherein calculating the picture order count further comprises:
   i. determining if a previous picture order count least significant bit is greater than or equal to a current picture order count least significant bit plus half of a maximum picture order count least significant bit,
   ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit,
   iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit,
   iv. otherwise the picture order count most significant bit is the previous picture order count most significant bit.
4. The method of clause 1 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.
5. A method of calculating a picture order count programmed in a memory of a device comprising:
   a. determining if a previous picture order count least significant bit is greater than or equal to a current picture order count least significant bit plus half of a maximum picture order count least significant bit;
   b. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit;
   c. otherwise if the picture order count least significant bit is greater than the previous picture order count least significant bit plus half of the maximum picture order count least significant bit, then the picture order count most significant bit is the previous picture order count most significant bit minus the maximum picture order count least significant bit; and
   d. otherwise the picture order count most significant bit is the previous picture order count most significant bit.
6. The method of clause 5 wherein calculating the picture order count avoids using “and” operations.
7. The method of clause 5 wherein calculating the picture order count is limited to two “compare” operations.
8. The method of clause 5 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.
9. An encoder within a device comprising:
   a. an acquisition module configured for acquiring video data; and
   b. an encoding module configured for encoding the video data including calculating a picture order count in the video data using signed or unsigned computing without using “and” operations.
10. The encoder of clause 9 wherein calculating the picture order count is limited to two “compare” operations.
11. The encoder of clause 9 wherein calculating the picture order count further comprises:
   i. determining if a previous picture order count least significant bit is greater than or equal to a current picture order count least significant bit plus half of a maximum picture order count least significant bit,
   ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit,
   iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit,
   iv. otherwise the picture order count most significant bit is the previous picture order count most significant bit.
12. The encoder of clause 9 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.
13. A decoder within a device comprising:
   a. an receiving module configured for receiving encoded video data; and
   b. an decoding module configured for decoding the encoded video data, wherein the encoded video data is encoded by calculating a picture order count in the video data using signed or unsigned computing without using “and” operations.
14. The decoder of clause 13 wherein calculating the picture order count is limited to two “compare” operations.
15. The decoder of clause 13 wherein calculating the picture order count further comprises:
   i. determining if a previous picture order count least significant bit is greater than or equal to a current picture order count least significant bit plus half of a maximum picture order count least significant bit,
   ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit,
   iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit,
   iv. otherwise the picture order count most significant bit is the previous picture order count most significant bit.
16. The encoder of clause 13 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.
17. An apparatus comprising:
   a. a non-transitory memory for storing an application, the application for:
      i. determining if a previous picture order count least significant bit is greater than or equal to a current picture order count least significant bit plus half of a maximum picture order count least significant bit;
      ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit;
      iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit; and
      iv. otherwise the picture order count most significant bit is the previous picture order count most significant bit; and
   b. a processing component coupled to the memory, the processing component configured for processing the application.
18. The apparatus of clause 17 wherein calculating the picture order count avoids using “and” operations.
19. The apparatus of clause 17 wherein calculating the picture order count is limited to two “compare” operations.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of video encoding programmed in a memory of a device comprising:
a. acquiring video data; and
b. encoding the video data, including calculating a picture order count in the video data using signed or unsigned computing without using “and” operations.

2. The method of claim 1 wherein calculating the picture order count is limited to two “compare” operations.

3. The method of claim 1 wherein calculating the picture order count further comprises:
i. determining if a previous picture order count least significant bit is greater than or equal to a current picture order count least significant bit plus half of a maximum picture order count least significant bit,
ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit,
iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit,
iv. otherwise the picture order count most significant bit is the previous picture order count most significant bit.

4. The method of claim 1 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

5. A method of calculating a picture order count programmed in a memory of a device comprising:
a. determining if a previous picture order count least significant bit is greater than or equal to a current picture order count least significant bit plus half of a maximum picture order count least significant bit;
b. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit;
c. otherwise if the picture order count least significant bit is greater than the previous picture order count least significant bit plus half of the maximum picture order count least significant bit, then the picture order count most significant bit is the previous picture order count most significant bit minus the maximum picture order count least significant bit; and
d. otherwise the picture order count most significant bit is the previous picture order count most significant bit.

6. The method of claim 5 wherein calculating the picture order count avoids using “and” operations.

7. The method of claim 5 wherein calculating the picture order count is limited to two “compare” operations.

8. The method of claim 5 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

9. An encoder within a device comprising:
a. an acquisition module configured for acquiring video data; and
b. an encoding module configured for encoding the video data including calculating a picture order count in the video data using signed or unsigned computing without using “and” operations.

10. The encoder of claim 9 wherein calculating the picture order count is limited to two “compare” operations.

11. The encoder of claim 9 wherein calculating the picture order count further comprises:
i. determining if a previous picture order count least significant bit is greater than or equal to a current picture order count least significant bit plus half of a maximum picture order count least significant bit,
ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit,
iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit,
iv. otherwise the picture order count most significant bit is the previous picture order count most significant bit.

12. The encoder of claim 9 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

13. A decoder within a device comprising:
a. an receiving module configured for receiving encoded video data; and
b. an decoding module configured for decoding the encoded video data, wherein the encoded video data is encoded by calculating a picture order count in the video data using signed or unsigned computing without using “and” operations.

14. The decoder of claim 13 wherein calculating the picture order count is limited to two “compare” operations.

15. The decoder of claim 13 wherein calculating the picture order count further comprises:
i. determining if a previous picture order count least significant bit is greater than or equal to a current picture order count least significant bit plus half of a maximum picture order count least significant bit,
ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit,
iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit,
iv. otherwise the picture order count most significant bit is the previous picture order count most significant bit.

16. The encoder of claim 13 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

17. An apparatus comprising:
a. a non-transitory memory for storing an application, the application for:
i. determining if a previous picture order count least significant bit is greater than or equal to a current picture order count least significant bit plus half of a maximum picture order count least significant bit;
ii. if the previous picture order count least significant bit is greater than or equal to the current picture order count least significant bit plus half of the maximum picture order count least significant bit, then a picture order count most significant bit is the previous picture order count most significant bit plus the maximum picture order count least significant bit;
iii. otherwise if the picture order count least significant bit is greater than the previous picture order count least significant bit plus half of the maximum picture order count least significant bit, then the picture order count most significant bit is the previous picture order count most significant bit minus the maximum picture order count least significant bit; and
iv. otherwise the picture order count most significant bit is the previous picture order count most significant bit; and
b. a processing component coupled to the memory, the processing component configured for processing the application.

18. The apparatus of claim 17 wherein calculating the picture order count avoids using “and” operations.

19. The apparatus of claim 17 wherein calculating the picture order count is limited to two “compare” operations.
